(19) United States
(12) Patent Application Publication
(10) Pub. No.: US 2025/0232362 A1
(43) Pub. Date: Jul. 17, 2025

(54) SYSTEMS AND METHODS FOR GENERATING A USER INTERFACE

(71) Applicant: Allstate Insurance Company, Northbrook, IL (US)

(72) Inventors: Reuel Neil JOSE, Vernon Hills, IL (US); Morgan MOSKY, Chicago, IL (US); Salvador LOPEZ, Lincolnton, NC (US); Marvin LU, Chicago, IL (US); Raja Sekhar THIRUVATHURU, Aurora, IL (US); Umamaheshwar R. UPPADA, Palatine, IL (US)

(21) Appl. No.: 18/985,184

(22) Filed: Dec. 18, 2024

Related U.S. Application Data
(60) Provisional application No. 63/615,920, filed on Dec. 29, 2023.

(51) Int. Cl. G06Q 30/0601; G06F 3/04842

(52) U.S. Cl. CPC G06Q 30/0641; G06F 3/04842

(57) ABSTRACT

Implementations claimed and described herein provide systems and methods for generating an user interface in response to a request associated with a product or service. The systems and methods use one or more machine learning models to generate the user interface. The user interface is transmitted to a user device for display.

### CROSS-REFERENCE TO RELATED APPLICATIONS

The present application claims priority to U.S. Provisional Patent Application No. 63/615,920 filed on Dec. 29, 2023, which is incorporated by reference in its entirety herein.

### FIELD

Aspects of the presently disclosed technology relate generally to systems and methods for generating a user experience and more particularly to generating an interactive user interface particular to a user based on user attributes.

### BACKGROUND

Many user interfaces are static and user independent, such that the same information is presented in the same way to each user. However, each user is different and may desire to interact with the information presented in various manners. It is with these observations in mind, among others, that various aspects of the present disclosure were conceived and developed.

### SUMMARY

Implementations described and claimed herein address the foregoing problems by providing systems and methods for processing user attributes to generate a personalized user experience. The systems and methods herein provide technical improvements to human-computer interaction (HCI) and interactive user interfaces, such as, for example, graphical user interfaces, by allowing for an improved ability to display information and interact with the user regarding a product and/or service by automatically manipulating the displayed information based on user attributes.

In some implementations, a computer implemented method can comprise: receiving a request associated with at least one of a product or a service, the request captured via an interaction with one or more input systems by a user, receiving user data associated with the user, generating an identification number based on the user data and the request using one or more machine learning models, generating an interactive user interface based on the identification number using the one or more machine learning models, the interactive user interface personalized to the user, and causing the interactive user interface to be presented using one or more output systems.

In some implementations, a system can comprise: a provider system in communication with a user device over a network, the user device having one or more input systems and one or more output systems, the provider system configured to receive a request captured via the one or more input systems through interaction of a user with the one or more input systems, the request associated with at least one of a product or a service, the provider system configured to receive user data associated with the user, an identification number generation system configured to generate an identification number based on the user data and the request using one or more machine learning models, and a user interface generation system configured to generate an interactive user interface based on the identification number using the one or more machine learning models, the interactive user interface personalized to the user, the provider system configured to cause the interactive user interface to be presented using the one or more output systems.

In some implementations, one or more tangible non-transitory computer-readable storage media store computer-executable instructions for performing a computer process on a computing system, the computer process can comprise: receiving a request associated with at least one of a product or a service, the request captured via an interaction with one or more input systems associated with a user device by a user, receiving user data associated with the user, generating an identification number based on the user data and the request using one or more machine learning models, generating an interactive user interface based on the identification number using the one or more machine learning models the interactive user interface personalized to the user, and causing the interactive user interface to be presented using one or more output systems associate with the user device.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example user experience generation system.

FIG. 2 illustrates an example provider system.

FIG. 3 illustrates an example computing system that may implement various aspects of the user experience generation system.

FIG. 4 illustrates example operations for user experience generation.

FIGS. 5-9 illustrates an example interactive user interface generated in response to a request regarding a product or a service.

### DETAILED DESCRIPTION

Aspects of the present disclosure involve systems and methods to process a request regarding a product or service received from a user to generate a user interface. The systems and methods described herein use one or more machine learning models to generate the user interface to provide an optimized, custom user experience. The one or more machine learning models is trained using historical data relating to successful closing of product or service sales. This results in a more user friendly interface that is customized using user data to drive successful sales of products or services. Additional advantages of the presently disclosed technology will become apparent from the detailed description below.

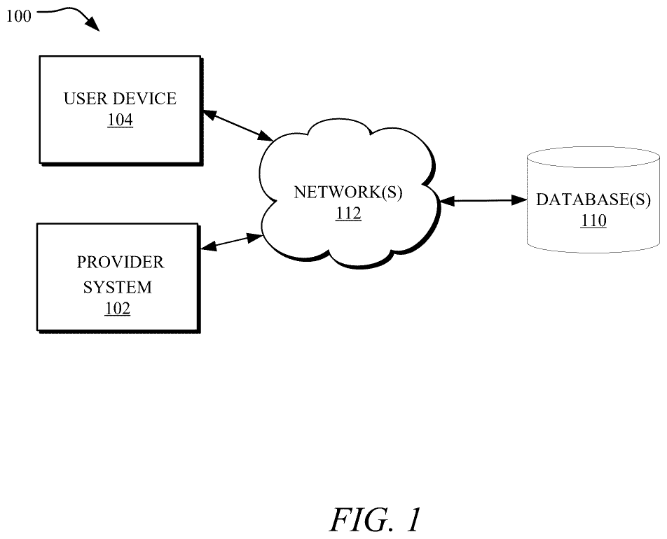

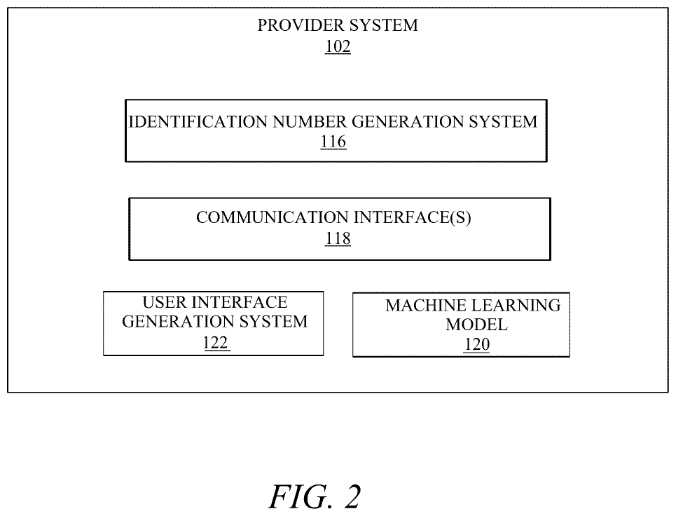

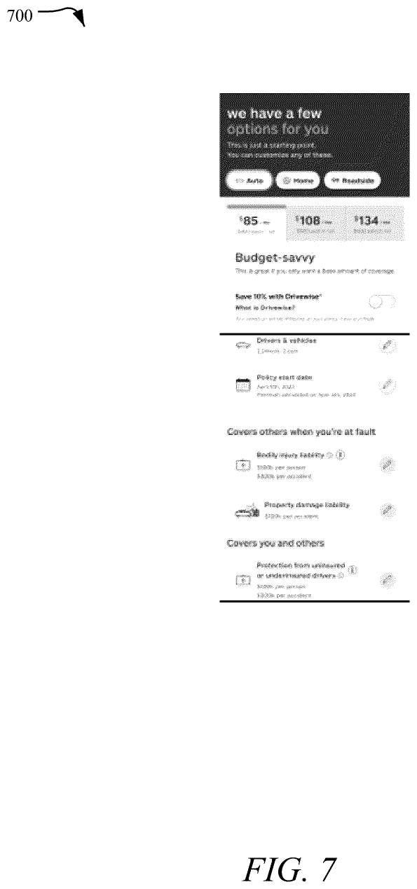

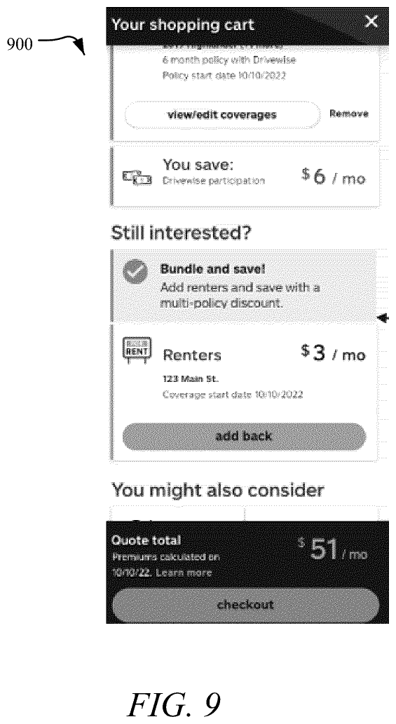

To begin a detailed description of an example user experience generation system 100 for generating an interactive user interface by processing a request related to purchasing a product or service, reference is made to FIGS. 1-9. The system 100 can include a provider system 102 configured to receive a request regarding a product and/or service and processing the request to generate an interactive user interface. The request is captured by a user via one or more input systems. For instance, the request is captured using text, audio, and/or interaction with an onboarding user interface presented using one or more output systems. The one or more input systems and the one or more output systems may be part of the user device 104 or separate from the user device 104. Upon receiving the request, the provider system 102 processes the request to generate an interactive user interface that is sent to the one or more output systems to be presented to the user. For instance, the interactive user interface is displayed by the user device 104. The system 100 may further include one or more databases 110. The provider system 102, the user device 104, and the one or more databases 110 are configured to interact with one another via a network(s) 112. As illustrated in greater detail below, any and/or all of the provider system 102, the identification number generation system 116, the user interface generation system 122, the user device 104, the one or more databases 110 may, in some instances, be special-purpose computing devices configured to perform specific functions.

The provider system 102 includes one or more computing devices (e.g., servers, routers, user interface devices, internet telephony computing device, and the like) that store and/or retrieve data in the one or more databases 110, provide user interfaces, phone system functionality, execute the identification number generation system 116 and/or the user interface generation system, etc. by processing instructions. The provider system 102 may include a communication interface(s) 118 that is able to communicate with the one or more input systems and one or more output systems via the network(s) 112. The provider system 102 can be configured to monitor and store (e.g., with appropriate permissions) communication from a user for further analysis and/or training of one or more machine learning models 120. In an implementation, the provider system 102 is configured to transmit the communication to another computing device or database, such as the one or more databases 110. In an implementation, the provider system 102 is associated with an organization or entity. In an implementation, the provider system 102 can retrieve and send policy and/or benefit information that indicates what product or services are currently available to the user.

The user device 104 includes one or more input systems and one or more output systems. The user is able to submit a request for a product or service to the provider system 102 via the one or more input systems (e.g., one or more user interfaces) using the user device 104. The user device 104 can be a computing device (e.g., smartphone, tablet, desktop computer, laptop computer, or other personal computing device) that may be used by an individual (e.g., a customer of an enterprise organization). In some instances, the user device 104 may be used to display recommendations and/or other alerts/graphical user interfaces.

In an implementation, the one or more machine learning models 120 is trained to support dynamic and customizable user experiences with regard to requests related to products and/or services. The machine learning model 120 can include a linear regression model, an unsupervised neural network model, gradient boosted trees, etc. The one or more machine learning models 120 may be built from historical user data associated with successful closing of sales of products and/or services stored, for example, at the one or more databases 110. In another implementation, historical user data associated with an unsuccessful closing of sales of products and/or services are stored at the one or more databases 110. The one or more machine learning models 120 leverages historical user data relating to a consumer to generate one or more user interfaces. In an implementation, weights are applied to the variables based on importance. For instance, the training set can include user data of consumers that resulted in a successful sale of a product or service, a high satisfaction rating from the consumer, etc. The historical user data can be extracted from a phone call, chat session, e-mail, etc. between a consumer and an employee of a provider using natural language processing, website visits, search engine entries, a quote start for products/services, a quote completion for products/services, survey queries, social media interactions, application downloads/interactions, telematics use, advertisement exposure, etc. The historical user data includes at least one of a life event (e.g., change in marital status, birth of a child, death, buying an asset, moving, graduating, etc.), brand loyalty, buying habits, internet search habits, digital behaviors, life-time value, age, race, ethnicity, gender, marital status, income level, education level, employment status, occupation, homeownership, zip code, location, years of driving experience, number of vehicles, year of vehicles, value of vehicles, number of accidents, number of insurance claims, age of home, value of home, location desirability, location density, years of being a customer, profitability, digital engagement, credit score, pet ownership, personal data subject to a data leak, years in residence, political affiliations, location crime data, etc. of consumers that purchased a product and/or service. Accordingly, the one or more machine learning models 120 allows the computing platform 106 to generate a user experience that is satisfying for a consumer, while still increasing the likelihood of a successful sale of the product or service.

In an implementation, the identification number generation system 116 uses the one or more machine learning models 120 to generate an identification number for the user based on user data associated with user attributes of the user and the historical user data. In an implementation, the historical user data corresponds with users having similar characteristics of the user. The user data can be received from one or more of the one or more databases 110 and user inputs via the user device 104. The user data includes at least one of age, race, ethnicity, gender, marital status, income level, education level, employment status, occupation, family size, homeownership, zip code, location, years of driving experience, number of vehicles owned by the user, year of vehicles owned by the user, value of vehicles owned by the user, number of accidents, number of insurance claims, age of home, value of home, location density, years of being a customer, profitability, digital engagement, credit score, previous engagement with the product or service, life changes, pet ownership, record data breach, years in residence, location desirability, location risk data, etc. of the user. In an implementation, the identification number is generated based in part using business goals and insights, such as long-term value, of the user to further personalize the user experience.

In an implementation, the provider system 102 includes instructions that direct and/or cause the user interface generation system 122 to generate one or more interactive user interfaces based on user data associated with user attributes of the user and the historical user data. In this implementation, the one or more interactive user interfaces may be generated using generative artificial intelligence. In an implementation, the provider system 102 includes instructions that direct and/or cause the user interface generation system 122 to generate one or more interactive user interfaces based on the identification number. The one or more interactive user interfaces guide the user through a process for purchasing a product and/or service. The use of a system allows for the generation of the one or more interactive user interfaces that are specific to the customer, such that no two user experiences are alike. This also allows for optimization of the user experience when the user makes subsequent requests.

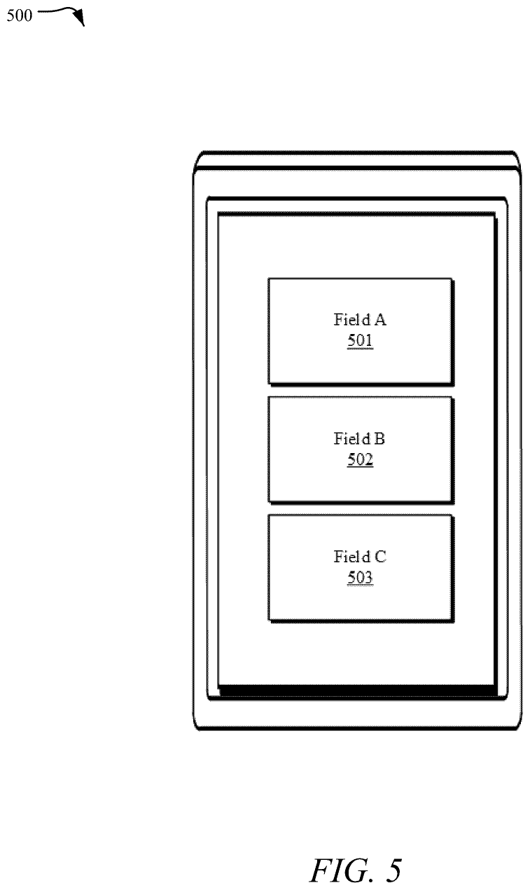

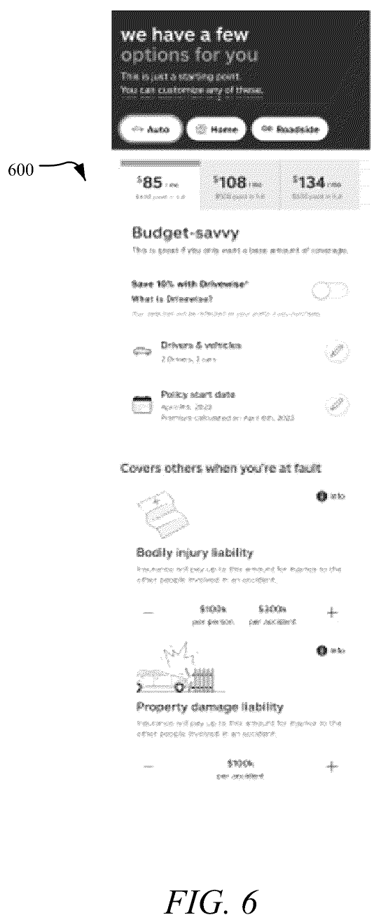

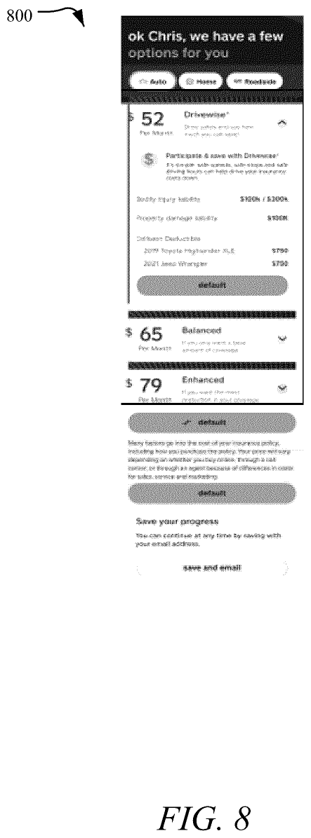

Referring to FIG. 5, an example user interface 500 is shown that is generated using the identification number. In this example, portions of the user interface, such as, field A 501, field B 502, and field C 503, are generated based on the identification number. For instance, location, content, font, font size, terms, and presentation for field A 501, field B 502, and field C 503 are based on the identification number. In an implementation one or more of field A 501, field B 502, and field C 503 include a type of product or service, a quote based on desired coverage, additional product and/or services recommended for the user, membership information, property information, an indication of savings, current coverage, a total amount of charges, an input to purchase the product or service, etc. FIGS. 6-9 illustrate various user interfaces 600-900 generated based on identification number. In an implementation, when the user data indicates that the user is likely cost conscious, the user interface may indicate how much money is being saved with the selected product and/or service or use terms similar to “Budget-savvy,” as illustrated in FIGS. 6, 7 and 9. In an implementation, when the user data indicates that the user is more affluent than the average consumer, the user interface may highlight how much coverage is being selected by using terms such as “Balanced,” “Enhanced,” etc., as illustrated in FIG. 8. In an implementation where the user data indicates that the user is a higher level user and/or a return user, the user interfaces generated may guide the user through a streamlined process to purchase the product and/or service. In an implementation where the user data indicates that the user is a lower level user and/or a first-time user, the user interfaces generated may guide the user through a detailed process to purchase the product and/or service.

The provider system 102 may have instructions that direct and/or cause the provider system 102 to receive a request associated with a product or service, receive user data, generate, via the identification number generation system 116, an identification number based on the user data using the one or more machine learning models 120, generate, via the user interface generation system 122, one or more interactive user interfaces based on the identification number, receive product and/or service selections associated with the product and/or service that the user wished to purchase, and provide the product and/or service to the user.

The network(s) 112 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 112 can include any type of network, such as the Internet, an intranet, a Virtual Private Network (VPN), a Voice over Internet Protocol (VOIP) network, a wireless network (e.g., Bluetooth), a cellular network, a satellite network, combinations thereof, etc. The network(s) 112 can include communications network components such as, but not limited to gateways routers, servers, and registrars, which enable communication across the network(s) 112. In one implementation, the communications network components include multiple ingress/egress routers, which may have one or more ports, in communication with the network(s) 112.

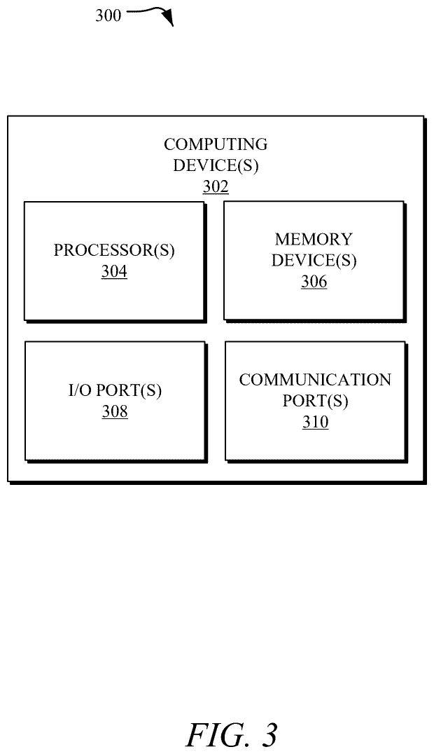

Turning to FIG. 3, a system 300 to generate an interactive user interface can include one or more computing devices 302 for performing the techniques discussed herein. In one implementation, the one or more computing devices 302 include the user device 104 and/or one or more servers of the provider system 102 to generate and execute the identification number generation system 116 and/or the user interface generation system 122 as a software application and/or a module or algorithmic component of software.

In some instances, the computing device 302 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device 302 may be integrated with, form a part of, or otherwise be associated with the systems 100-300. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein. Moreover, the computing device 302, as implemented in the systems 100-300, receives various types of input data (e.g., the text communication) and transforms the input data through various stages of the data flow into new types of data files (e.g., generate a user interface in response to the request using one or more machine learning models), which enables the computing device 302 to do something it could not do before-generate a user interface in response to a request associated with a product and/or service using one or more machine learning models trained using historical user data.

Additionally, the systems and operations disclosed herein represent an improvement to the technical field of human-computer interaction (HCI), interactive user interfaces, and machine learning processing. For instance, the computing platform 106 can generate an interactive user interface regarding a product and/or service that is optimized for the user making the request. Moreover, data can be leveraged from different data sources with varying levels of abstraction to provide a highly customized user interface. These techniques are rooted in technology and could not have existed prior to the advent of machine learning analytics.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302.

The I/O port 308 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network(s) 112 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

In an example, the provider system 102, and/or other software, modules, services, and operations discussed herein may be embodied by instructions stored on the memory device(s) 306 and executed by the processor 304.

The system set forth in FIG. 3 is but one possible example of a computing device 302 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 302.

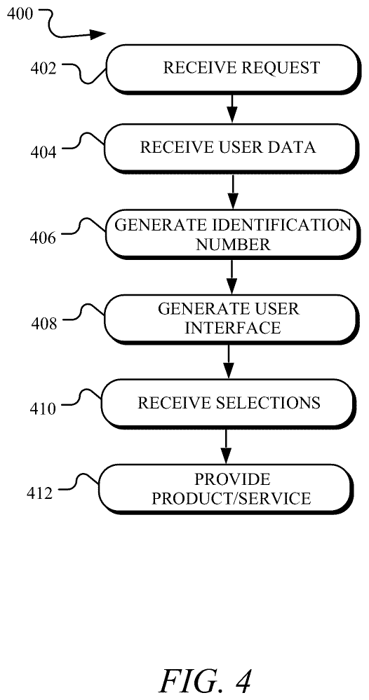

FIG. 4 depicts an example method 400 to generate an interactive user interface in response to a request relating to a product and/or service, which can be performed by any of the systems 100-300 discussed herein. The method 400 can, in some instances, occur in real time.

At operation 402, the method 400 can receive a request associated with at least one of a product or a service, the request captured via an interaction with one or more input systems by a user, such as, for example, via a user device 104. The request is associated with a product and/or service and is a communication inputted by a user via one or more input systems, such as, for example, via the user device 104. In an implementation, the communication is a voice input and/or a textual input. In an implementation, the request can be related to a quote for the product and/or service. In this instance, the request may state, “start my quote” or “help me choose a product.” In another implementation, the request can be related to asking about a specific product or service. In this instance, the query may state, “start my quote for xyz product.”

At operation 404, the method 400 receives user data associated with the user. In an implementation, at least a portion of the user data is received from the one or more databases 110. In another implementation, the user data is received via user inputs via one or more input systems, such as, for example, via the user device 104.

At operation 406, the method 400 generates an identification number by inputting the user data into the one or more machine learning models 120.

At operation 408, the method 400 generates an interactive user interface using the one or more machine learning models 120 and the identification number. Example recommendation user interfaces 500-900 are shown in FIGS. 5-9. In an implementation, the user interface includes one or more of a plurality of interactive user interfaces configured to guide a user to purchase a product and/or service. In an implementation, the plurality of interactive user interfaces include selectable products and/or services, a price change compared to a current product and/or service used by the user, a recommended additional product and/or service, an explanation of the product and/or service, a comparison with products and/or services used by users with similar characteristics as the user, and other notifications associated with the product and/or service.

At operation 410, the method 400 receives a user selection indicating the service and/or product the user desires to purchase. In an implementation, the user selection is selected by the user via the interactive user interface displayed on the user device 104.

At operation 412, the method 400 provides the service and/or product to the user. For instance, the method 400 subscribes the user to the service and/or product offered by the provider, such as a policy.

It is to be understood that the specific order or hierarchy of operations in the methods depicted in FIG. 4 and throughout this disclosure are instances of example approaches and can be rearranged while remaining within the disclosed subject matter. For instance, any of the operations depicted in FIG. 4 may be omitted, repeated, performed in parallel, performed in a different order, and/or combined with any other of the operations depicted in FIG. 4 or discussed herein.

In an implementation, the provider system 102 generates an interactive user experience via an audio output, such as, for example during a phone call with a user to assist the user in making a purchase of a product and/or service. In this implementation, the provider system 102 includes a natural language processing module that processes the output of the one or more machine learning models before outputting an audio output to guide the user through a purchasing process. In another implementation, the natural language processing module processes input data from the user device and/or data retrieved from the one or more databases 110.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A system comprising:
a provider system in communication with a user device over a network, the user device having one or more input systems and one or more output systems, the provider system configured to receive a request captured via the one or more input systems through interaction of a user with the one or more input systems, the request associated with at least one of a product or a service, the provider system configured to receive user data associated with the user; and
a user interface generation system configured to generate an interactive user interface based on the user data and the request using one or more machine learning models, the interactive user interface personalized to the user, the provider system configured to cause the interactive user interface to be presented using the one or more output systems.

2. The system of claim 1, further comprising:
an identification number generation system configured to generate an identification number based on the user data and the request using the one or more machine learning models, the interactive user interface generated using the identification number.

3. The system of claim 1, wherein the provider system is configured to receive a user selection via the one or more input systems through interaction by the user with the interactive user interface, the user selection indicating at least one of the service or the product the user desires to purchase.

4. The system of claim 1, wherein the interactive user interface is one of a plurality of user interfaces configured to direct the user through a process to purchase at least one of the product or the service.

5. The system of claim 4, wherein the plurality of user interfaces include at least one of selectable inputs associated with at least one of the product or the service, a price change compared to at least one of a current product or a current service used by the user, a recommendation indicating at least one of an additional product or an additional service, an explanation of at least one of the product or the service, a comparison to consumers with similar characteristics as the user, or a notifications associated with at least one of the product or the service.

6. The system of claim 1, wherein the user data includes at least one of age, race, ethnicity, gender, marital status, income level, education level, employment status, occupation, family size, homeownership, a zip code associated with a home of the user, years of driving experience, number of vehicles owned by the user, age of one or more vehicles owned by the user, value of one or more vehicles owned by the user, a number of accidents, a number of insurance claims, an age of the home owned by the user, a value of the home owned by the user, location density of a location associated with the home of the user, years of being a customer, profitability of the user, digital engagement of the user, or a credit score of the user.

7. The system of claim 1, wherein the interactive user interface includes a plurality of portions, each of the plurality of portions are individually generated based on the user data and the request using the one or more machine learning models.

8. A method comprising:
receiving a request associated with at least one of a product or a service, the request captured via an interaction with one or more input systems by a user;
receiving user data associated with the user;
generating an interactive user interface based on the user data and the request using one or more machine learning models, the interactive user interface personalized to the user; and
causing the interactive user interface to be presented using one or more output systems.

9. The method of claim 8, wherein the interactive user interface includes a plurality of portions, each of the plurality of portions are individually generated based on the user data and the request using the one or more machine learning models.

10. The method of claim 8 further comprising:
receiving a user selection via the one or more input systems through interaction by the user with the interactive user interface, the user selection indicating at least one of the service or the product the user desires to purchase.

11. The method of claim 8, wherein the interactive user interface is one of a plurality of interactive user interfaces configured to guide the user to purchase at least one of the product or the service.

12. The method of claim 11, wherein the plurality of interactive user interfaces include at least one of selectable inputs associated with at least one of the product or the service, a price change compared to at least one of a current product or a current service used by the user, a recommendation indicating at least one of an additional product or an additional service, an explanation of at least one of the product or the service, a comparison to consumers with similar characteristics as the user, or a notification associated with at least one of the product or the service.

13. The method of claim 8, wherein the user data includes at least one of age, race, ethnicity, gender, marital status, income level, education level, employment status, occupation, family size, homeownership, a zip code associated with a home of the user, years of driving experience, number of vehicles owned by the user, age of one or more vehicles owned by the user, value of one or more vehicles owned by the user, a number of accidents, a number of insurance claims, an age of the home owned by the user, a value of the home owned by the user, location density of a location associated with the home of the user, years of being a customer, profitability of the user, digital engagement of the user, or a credit score of the user.

14. The method of claim 8, further comprising:
generating an identification number based on the user data and the request using the one or more machine learning models, the interactive user interface generated using the identification number.

15. The method of claim 8, wherein the one or more input systems and the one or more output systems are integrated into a user device.

16. One or more tangible non-transitory computer-readable storage media storing computer-executable instructions for performing a computer process on a computing system, the computer process comprising:
receiving a request associated with at least one of a product or a service, the request captured via an interaction with one or more input systems associated with a user device by a user;
receiving user data associated with the user;
generating an interactive user interface based on the user data and the request using one or more machine learning models the interactive user interface personalized to the user; and
causing the interactive user interface to be presented using one or more output systems associate with the user device.

17. The one or more tangible non-transitory computer-readable storage media storing computer-executable instructions for performing the computer process on the computing system of claim 16, wherein the one or more machine learning models is trained using historical user data relating to one or more consumers purchasing at least one of the product or the service.

18. The one or more tangible non-transitory computer-readable storage media storing computer-executable instructions for performing the computer process on the computing system of claim 16, the computer process further comprising:
generating an identification number based on the user data and the request using the one or more machine learning models, the interactive user interface generated using the identification number.

19. The one or more tangible non-transitory computer-readable storage media storing computer-executable instructions for performing the computer process on the computing system of claim 16, wherein the interactive user interface is one of a plurality of interactive user interfaces configured to guide the user to purchase at least one of the product or the service.

20. The one or more tangible non-transitory computer-readable storage media storing computer-executable instructions for performing the computer process on the computing system of claim 19, wherein the plurality of interactive user interfaces include at least one of selectable inputs associated with at least one of the product or the service, a price change compared to at least one of a current product or a current service used by the user, a recommendation indicating at least one of an additional product or an additional service, an explanation of at least one of the product or the service, a comparison to consumers with similar characteristics as the user, or a notification associated with at least one of the product or the service.
